(19) United States
(12) Patent Application Publication
(10) Pub. No.: US 2010/0030592 A1
(43) Pub. Date: Feb. 4, 2010

(54) TRANSMITTING INFORMATION FROM A MOBILE DEVICE TO A POINT OF SALE OR POINT OF USE

(75) Inventors: Geoffrey D. Evans, Minneapolis, MN (US); Gail L. Cannon, Excelsior, MN (US); John F. Lemke, Spokane Valley, WA (US); Alexander E. Osipov, Novosibirsk (RU)

Correspondence Address: WESTMAN CHAMPLIN & KELLY, P.A., SUITE 1400, 900 SECOND AVENUE SOUTH, MINNEAPOLIS, MN, 55402, US

(73) Assignee: Mobilocity Solutions LLC, Minnetonka, MN (US)

(21) Appl. No.: 12/512,629

(22) Filed: Jul. 30, 2009

Related U.S. Application Data
(63) Continuation-in-part of application No. 11/947,127, filed on Nov. 29, 2007.
(60) Provisional application No. 60/868,069, filed on Nov. 30, 2006.

(51) Int. Cl. G06K 5/00; G06Q 10/00; G06Q 50/00; G06Q 30/00; H04M 1/00

(52) U.S. Cl. 705/5; 705/13; 705/17; 705/18; 235/382; 455/556.1; 235/454

(57) ABSTRACT

A mobile device includes a light source and a light source controller. Data to be transmitted to a point of sale or point of use is obtained by the mobile device, and the light source controller controls the light emitted by the light source to emit light in a blinking pattern that simulates light that would be reflected to a laser scanner when a laser scanner is reading a barcode corresponding to the data to be transmitted. The light, emitted in the blinking pattern, is detected by a laser scanner which then decodes the data represented by the blinking pattern to obtain the data transmitted from the mobile device.

### CROSS-REFERENCE TO RELATED APPLICATION

The present application is a continuation-in-part of and claims priority of U.S. patent application Ser. No. 11/947,127, filed Nov. 29, 2007, the content of which is hereby incorporated by reference in its entirety, which is based on and claims the benefit of U.S. provisional patent application Ser. No. 60/868,069, filed Nov. 30, 2006, entitled “CONSUMER DISCOUNTS AND OFFERS PROVIDED VIA WIRELESS DEVICES, COMBINED WITH A GPS NAVIGATIONAL COMPONENT DIRECTING THE CONSUMER TO THE APPROPRIATE RETAIL LOCATION” the content of which is hereby incorporated by reference in its entirety.

### BACKGROUND OF THE INVENTION

The use of coupons to obtain discounts at retail establishments is in wide use, and has been for many years. Normally, a retail customer buys items at a retail store, and at the point of sale, hands paper coupons to the cashier. The cashier then either manually keys in the numbers that identify each particular coupon being redeemed by the customer, or those numbers can sometimes be read automatically. Currently, the numbers that identify the coupons are read automatically by scanning a barcode representation of those numbers that appears on the individual coupons. The scanners currently come in a number of different types. One type is an image scanner which basically captures an image or picture of the barcode and compares it against barcode representations of numbers stored in a memory, to obtain the numbers that correspond to that barcode. A second type of scanner is conventionally known as a laser scanner. A laser device impinges radiation on the barcode, so that the individual bars on the barcode can be detected and translated into numbers.

There are a number of problems associated with current transactions that involve coupons. Paper coupon distribution is currently a very ineffective way of increasing consumer traffic in stores that sell the goods for which the coupons are redeemed. Also, many commercial transactions are becoming far less paper intensive, and therefore retail consumers are less likely to carry paper coupons to a retail establishment. This is evidenced by the fact that there are currently approximately 300 billion coupons distributed through the mail, circulars, newspapers and other print media, per year. That number is actually increasing yearly, but the redemption rate (the number of coupon redemptions) is decreasing each year. Therefore, manufacturers of retail goods are trying harder to increase consumer traffic with respect to their goods, by distributing more coupons, but the retail consumers are actually redeeming fewer coupons.

Similarly, in the past, the newspaper has been a primary medium by which coupons are distributed. Because of a variety of alternative news sources, newspaper circulation is declining.

Also, it is currently very difficult to monitor the effectiveness of a coupon promotion. Each retailer collects redeemed coupons and reports back to the coupon distributor the number of coupons redeemed over a given time period. Because of the sheer volume of coupons, the number of coupons redeemed is estimated by placing the coupons in a bag and then weighting the bag. This is extremely inaccurate. Also, because this reporting can take weeks, it is very difficult for a coupon distributor to gauge the effectiveness of any given promotion or to modify it, or otherwise respond, in real time.

At the same time, the use of cellular telephones and other similar mobile devices is increasing at a dramatic rate. Such mobile devices are also being used for more than merely voice communication. In fact, they are being used as sources of entertainment, sources for efficient integrated communications (such as electronic mail messaging, text messaging, voice messaging, etc.) and can even be used to run applications completely unrelated to communications. For instance, some mobile devices run applications that allow a user to remotely control items (appliances, HVAC equipment, etc.) in the home. Still other applications involve calendar functions, scheduling meeting requests, and even documenting landmarks during a women's pregnancy (such as when the heartbeat was first heard, when the first kick was felt, etc.).

Problems arise, however, when a manufacturer of retail goods wishes to distribute a coupon over networks that support mobile devices (such as telephone networks, wide area networks—e.g. the internet, cellular networks, etc.). One problem is that it is very difficult to render a coupon on the screen of a mobile device such that its barcode can be automatically scanned, such as by a fixed or handheld scanner (e.g., an image scanner, or laser scanner). The mobile device screen often reflects radiation (or at least a portion of the radiation) that is impinged on it, and this makes it difficult for either an image scanner or laser scanner to capture or decipher an image with sufficient resolution that the barcode can be accurately identified and translated into its numeric equivalent.

### SUMMARY OF THE INVENTION

A mobile device includes a light source and a light source controller. Data to be transmitted to a point of sale or point of use is obtained by the mobile device, and the light source controller controls the light emitted by the light source to emit light in a blinking pattern that simulates light that would be reflected to a laser scanner when a laser scanner is reading a barcode corresponding to the data to be transmitted. The light, emitted in the blinking pattern, is detected by a laser scanner which then decodes the data represented by the blinking pattern to obtain the data transmitted from the mobile device.

### BRIEF DESCRIPTION OF THE DRAWINGS

FIG. 1 is a block diagram of a coupon distribution and redemption system in accordance with one embodiment.

FIG. 2 is a more detailed block diagram of one embodiment of a coupon management system shown in FIG. 1.

FIG. 3 is a more detailed block diagram of a mobile device in accordance with one embodiment.

FIG. 3A shows one illustrative screenshot displaying an actuable user interface on a mobile device.

FIG. 4 is a flow diagram illustrating one embodiment of the overall operation of the system shown in FIG. 1.

FIG. 5 is a flow diagram illustrating one embodiment in which a barcode is rendered for scanning by the mobile device.

FIGS. 6A and 6B show one embodiment of an illustrative mobile device.

FIG. 7 is a block diagram illustrating one embodiment in which information is transmitted from the mobile device to a point of sale or point of use.

FIG. 8 is a flow diagram illustrating the overall operation of the system shown in FIG. 7.

FIG. 9 is a more specific flow diagram illustrating one more specific implementation of using the system shown in FIG. 7.

### DETAILED DESCRIPTION OF ILLUSTRATIVE EMBODIMENTS

The present system can be used to render barcodes on a mobile device for a wide variety of applications. For instance, barcodes can be used for authentication purposes such as membership or identification in a loyalty program or health club or other club. They can also be used as a unique identifier to provide special offers or multiple offers (as opposed to individual coupon offers) all redeemable with a single “umbrella” barcode that can be sent to qualifying individuals. Similarly, barcodes can be used as a form of payment (such as to identify a bank account, credit card, debit card, membership in an automatic payment service, etc.). However, for purposes of the present application, rendering barcodes will be discussed in the context of redeeming coupons for the sake of example only.

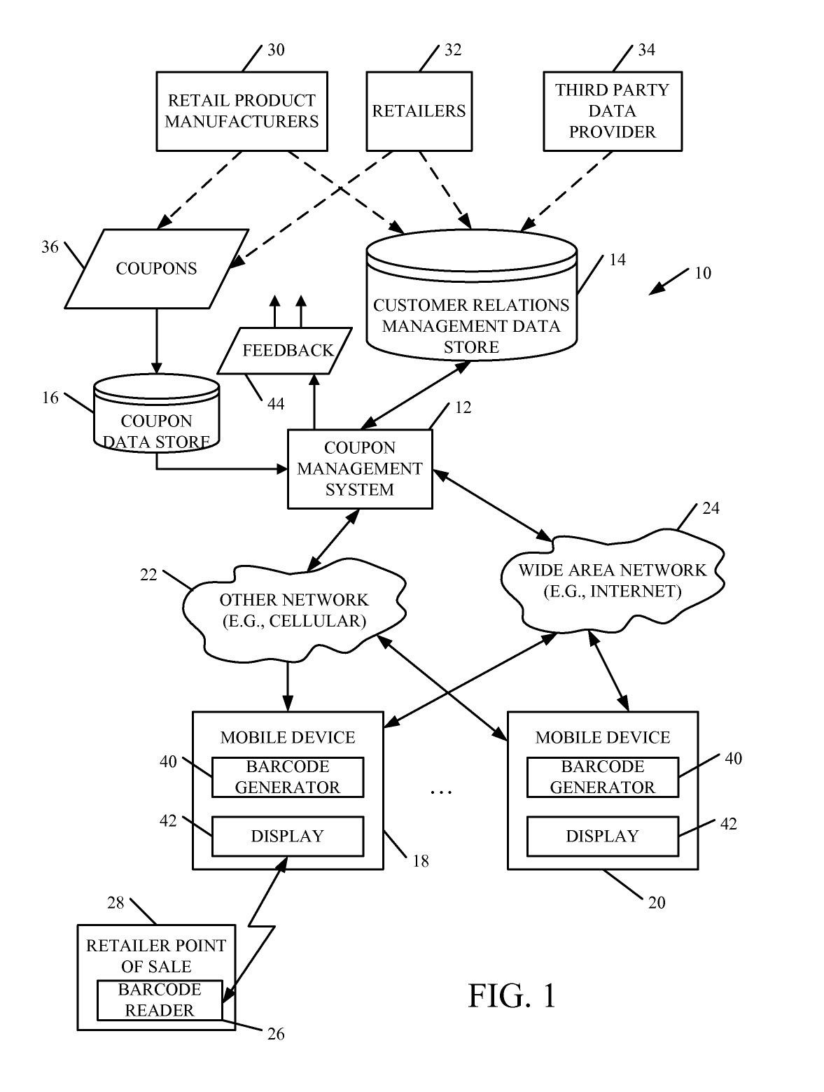

FIG. 1 is a block diagram of one embodiment of a coupon distribution and redemption system 10 in accordance with one embodiment. System 10 includes coupon management system 12 that has access to customer relations management data store 14 and coupon data store 16. System 10 also includes a plurality of mobile devices 18 and 20 that are connected to coupon management system 12 through one of a plurality of different networks 22 and 24. Mobile devices 18 and 20 are configured to render barcodes associated with coupons that can be scanned by barcode readers 26 at retailer point of sale locations 28.

System 10 also shows that the customer relations management data and the coupons 36 can be provided by a variety of different sources, such as retail product manufacturers 30, retailers 32 and third party data providers 34. One or all of these sources of customer relations management data provide that data to data store 14. The data illustratively includes the buying patterns of individual customers, such as what types of products the customers buy, how often the individual customers buy products, where the customers buy those products (such as what stores they buy them at), when the customers buy those products (such as a day of the week, the time of day, etc.) and any of a wide variety of other information. As mentioned above, the customer relations management data can come from third party data provider 34 which simply collects the data from a variety of retailers and provides it to system 10.

Coupons 36, that are distributed for redemption in system 10, can also be provided by a number of different sources. For instance, coupons for individual products can be provided by the retail product manufactures 30 or by the retailers 32 that sell those products.

Coupon management system 12 has access to the customer relations management data in data store 14 as well as coupons in data store 16 so it can identify what customers are likely to redeem which coupons. Coupon management system 12 can also take into account other information as well. For instance, any information stored in data store 14 can be used to generate targeted offers which target the users of mobile devices 18 and 20. That information may include the time of day or day of week that a particular user might most likely redeem any given coupon in data store 16. The information may also include, for example, the geographic location of the users of mobile devices 18 and 20. For instance, each mobile device 18 and 20 may illustratively be provided with a geographical positioning component which identifies the geographical location of the particular mobile device 18-20. Mobile devices 18-20 may, for example, be fitted with global positioning system (GPS system) components.

In any case, coupon management system 12 generates targeted offers for the users of mobile devices 18-20 and retrieves coupons for those targeted offers from coupon data store 16 and sends them to mobile devices 18-20. This can be done over either or both of networks 22-24, or other networks as well.

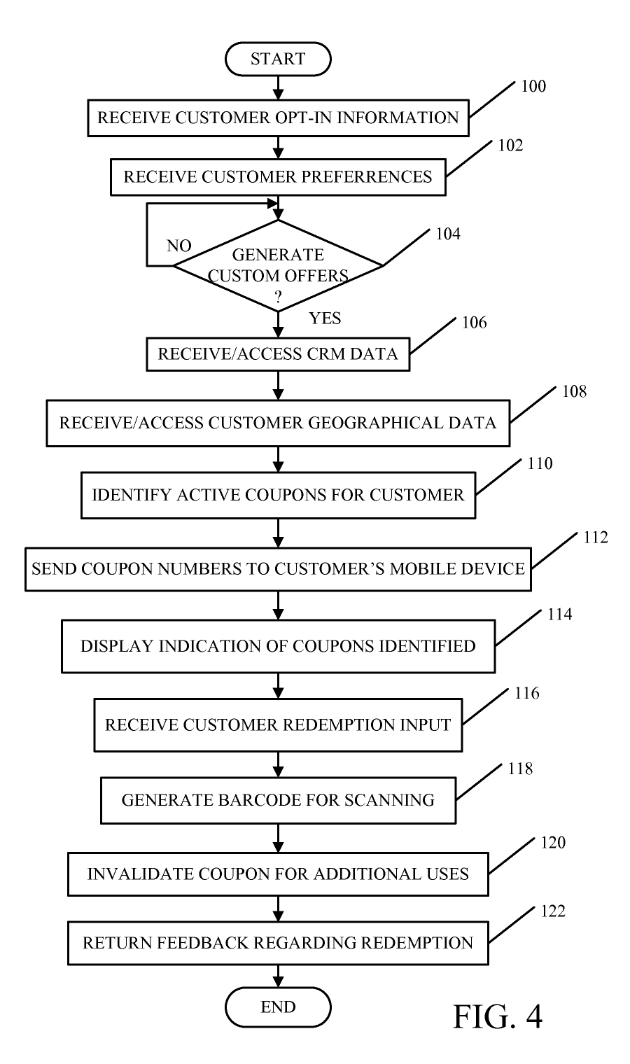

Mobile devices 18-20 are described in greater detail with respect to FIG. 4 below. However, suffice it to say for now that each mobile device 18-20 illustratively includes a barcode generator 40 and a display 42.

Mobile devices 18-20 illustratively display the downloaded coupons (or make them available for display) on display 42. A user of the mobile device can then view the offer or coupon and select a coupon for redemption. When a user of mobile devices 18-20 selects a coupon for redemption, barcode generator 40 generates a representation of the barcode on display 42 that is scannable (or readable) by electronic barcode reader 26 at point of sale 28 at a retailer. Barcode reader 26 is illustratively an image scanner, or a laser scanner, and can be a fixed scanner or a handheld scanner, as desired. In any case, once the coupon is displayed to be scanned, mobile device 18-20 transmits back to coupon management system 12 an indication that the coupon has been redeemed. Coupon management system 12 can then aggregate the coupon redemptions and report back (through feedback data 44) which coupons have been redeemed, at which stores, by which users, etc. Feedback data 44 can be stored for access by the retailers 32, retail product manufactures 30, or third party data providers 34, or it can be transmitted directly to them.

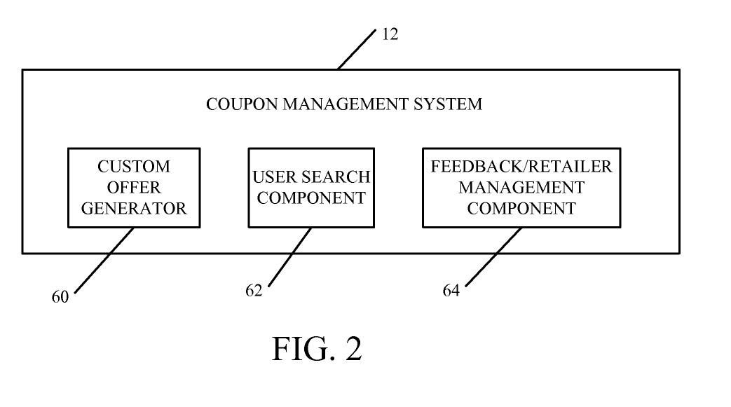

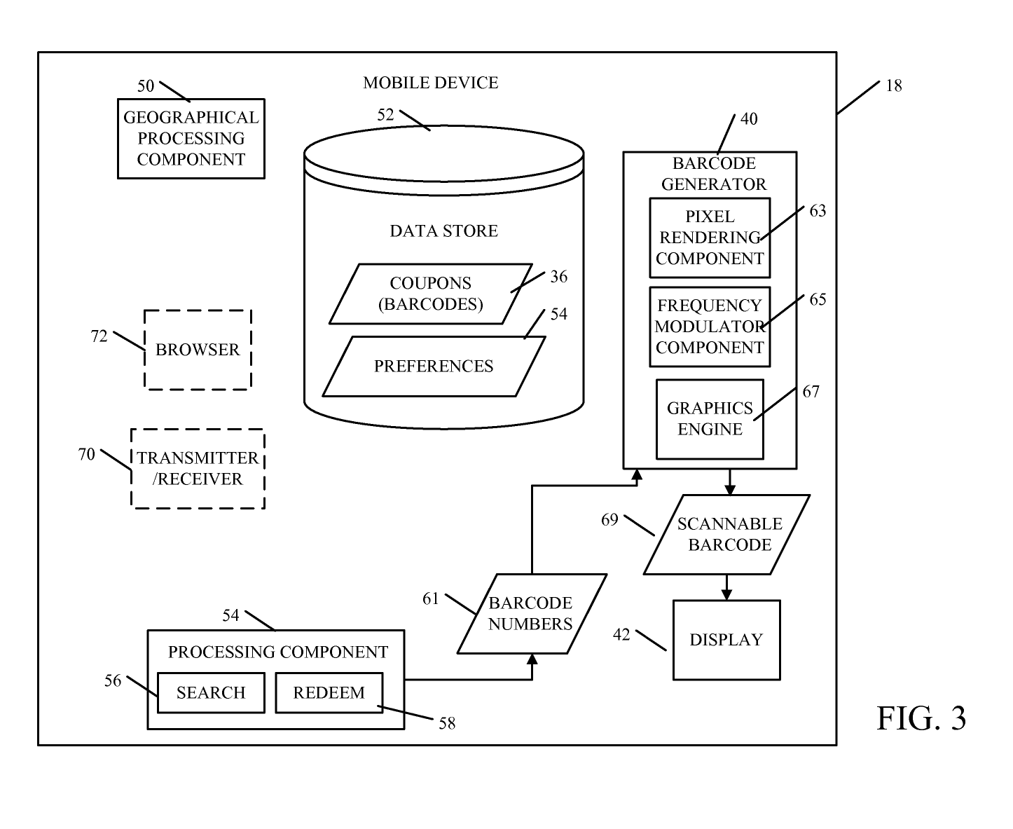

FIG. 2 is a more detailed block diagram of one embodiment of coupon management system 12. It should be noted that coupon management system 12 can be a separate system, separate from mobile devices 18-20, or the functionality of coupon management system 12 can be implemented completely, or partially, on mobile devices 18-20, as desired. For purposes of the present discussion, the functionality of coupon management system 12 will be described as a separate system 12 connected to mobile devices 18-20 through networks 22 and/or 24. Of course, other embodiments can be used as well.

In any case, in one embodiment, coupon management system 12 includes custom offer generator 60, user search component 62 and feedback/retailer management component 64. In the embodiment shown in FIG. 2, custom offer generator 60 receives an indication of which coupons 36 are provided in coupon data store 16, and also receives the customer relation management data from data store 14, and optionally additional information, such as the geographic location of mobile devices 18-20, etc., and generates the targeted offers, which are targeted at individual users of mobile devices 18-20, or groups of users. The offers may include not only a transmission of coupons which customer offer generator 60 identifies as relevant to a given user (i.e., one that the user may wish to redeem) but it may also include graphical or textual advertising information describing the offer, the coupons, or other items associated with coupon redemption, that the user might find helpful. For instance, the offer can direct the user to a nearest retailer where the coupon can be redeemed.

User search component 62 allows a user of mobile device 18 to search through coupon data store 16 for coupons that the user may find helpful. It will be noted that, in one embodiment, mobile device 18 has a browser application that includes a search engine that can be used to conduct searches. In another embodiment, the user of mobile device 18 simply interacts through the appropriate network 22-24 with coupon management system 12, and uses user search component 64 to conduct a search. Search component 64 may illustratively allow the user to search by keywords, by retailers, by products, by brand name, or by any other search criteria which may be desirable. In any case, the user can illustratively locate and download coupons from coupon data store 16, through coupon management system 12, using user search component 62. The user can then place the coupons in a desired location in a data store on mobile device 18 and can then select desired coupons for redemption, once the point of sale at a retailer has been reached.

Feedback/retailer management component 64 illustratively allows the entity offering the coupons to specify which type of users custom offers generator 60 should extend targeted offers to, and the coupons that are to be offered. This can be done in a wide variety of ways. For instance, assume that retailer 32 is offering coupons 36. Retailer 32 can interact with coupon management system 12 through feedback/retailer management component 64 (which may simply be an interface component that offers actuable user interfaces that can be actuated by a user at retailer 32 to specify targeted offers). Retailer 32 might specify users by gender, shopping or buying patterns, or by any other desirable information. Retailer 32 may also parameterize the coupon usage, such as by specifying how long the coupons are valid, when they expire, etc.

Feedback/retailer management component 64 also illustratively aggregates redemption data indicative of which coupons were redeemed, and under what circumstances. For instance, it may aggregate the number of coupons for a given product that were redeemed, the stores they were redeemed at, the times and places they were redeemed, the particular mobile devices 18-20 from which they were redeemed, etc. This type of information is currently substantially unavailable to coupon distributors. If it is available at all, it is generally not available until days or even weeks after redemption and can be highly inaccurate and imprecise. The present system illustratively provides this information substantially immediately.

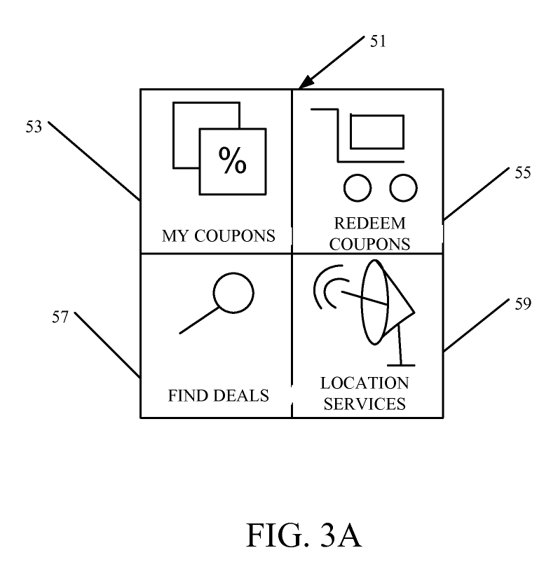

FIG. 3 is a block diagram illustrating one embodiment of a mobile device (such as mobile device 18) in more detail. FIG. 3A is one exemplary screenshot 51 showing an interface with user actuable inputs 53, 55, 57 and 59. As described below, user actuable input 53 allows a user to view already downloaded coupons, input 55 allows a user to select coupons and have them displayed for redemption, input 57 allows a user to search for coupons and input 59 allows a user to opt into specific geographic location services.

The embodiment of mobile device 18 shown in FIG. 3 includes geographical processing component 50, data store 52 that illustratively stores downloaded coupons 36 (with associated barcodes) and user preferences 54. The user preferences 54 may indicate a wide variety of preferences, such as when a user desires to receive new targeted offers (including coupons), the particular retailers or retail products for which the user desires to receive coupons, whether the user desires to participate in geographically targeted offers, etc. FIG. 3 also shows that mobile device 18, illustratively includes barcode generator 40 and display 42. Processing component 54, which is also part of mobile device 18 illustratively performs a wide variety of processing, such as obtaining the geographical information from geographical processing component 50 and passing it on to other desired components in the system. Processing component 54 also illustratively generates a user interface allowing a user to search for coupons using a search component 56, and allowing the user to select coupons for redemption, using a redeem component 58.

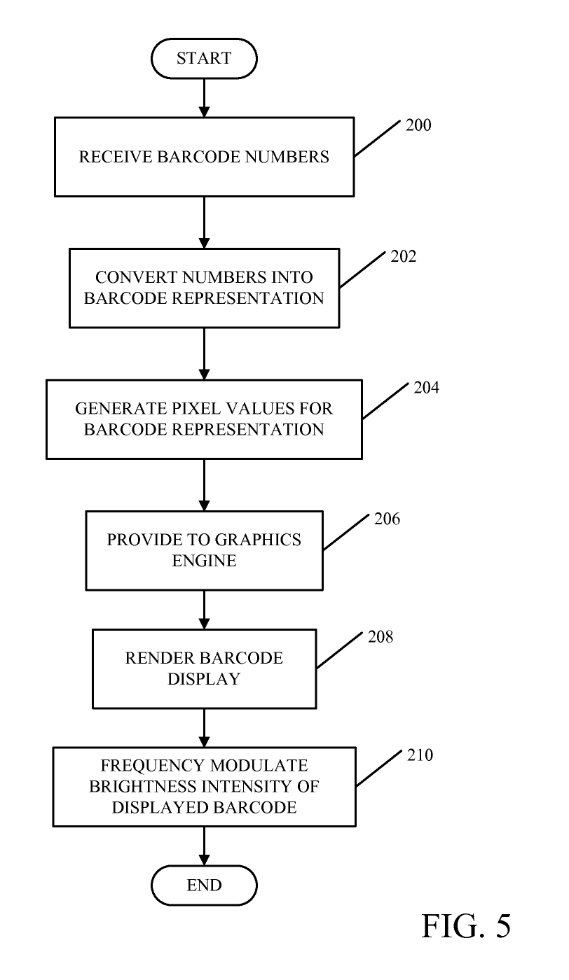

Components 56 and 58 illustratively generate user interfaces that can be actuated by the user to conduct searching, or to cause barcode generator 40 to render a barcode display, corresponding to a coupon to be redeemed, such that it can be scanned by a scanner. Illustratively, when a user has actuated redeem component 58 to redeem a coupon, processing component 54 retrieves the numbers corresponding to the coupon and provides that as barcode number 60 to barcode generator component 40. Barcode generator component 40 illustratively generates the barcode, as will be discussed in more detail with respect to FIG. 5. Suffice it to say, for now, that barcode generator 40 includes pixel rendering component 63, frequency modulator component 65 and graphics engine 67. Barcode generator 40 generates the scannable barcode 69 and provides it to display 42, where it is displayed for scanning and, thus, redemption.

FIG. 3 also shows that mobile device 18 illustratively includes a transmitter/receiver 70. Transmitter/receiver 70 may illustratively include radio hardware that transmits radio frequency signals over an appropriate network, to other desired components in the system. Of course, transmitter/receiver 70 may be equipped to receive such transmissions as well, and it can be configured not only as radio hardware, but any other hardware or software that can be used to transmit and receive information over a desired network.

Mobile device 18 may also optionally include a browser (such as a web browser) 72 that can be used over an appropriate network, to access the functionality of coupon management system 12, such as to search for coupons.

Geographical processing component 50 illustratively includes a global positioning system (or other such systems such as LORAN) that periodically updates geographic position information using at least longitude and latitude, that indicates the location of the mobile device in which it is installed. Component 50 may also illustratively perform processing using the location of the mobile device relative to preferences 54. For instance, where a user has set preferences indicating a desire to have coupons displayed for selection as the user is walking into a given retail business (such as a department store) geographical processing component 50 illustratively indicates to processing component 54 that the coupons are to be displayed for a given retail store, when the mobile device 18 is closely proximate the retail store. Of course, geographical processing component 50 may also simply output the geographical location of mobile device 18 to processing component 54 so that it can be transmitted to coupon management system 12, for further processing.

FIG. 4 is a flow diagram illustrating one illustrative embodiment of the overall operation of the system shown in FIG. 1. Again, the functionality of coupon management system 12 can be installed on, and implemented in, mobile devices 18-20. However, for the sake of the present discussion, the architecture shown in FIG. 10 will be discussed.

Coupon management system 12 first receives customer opt-in information. In one embodiment, this information indicates whether the user of the given mobile devices wishes to have the user information (identifying purchasing trends, geographical location, etc.) used by coupon management system 12. Receiving the customer opt-in information is indicated by block 100 in FIG. 4. The customer opt-in information may be provided through a suitable user interface displayed on mobile devices 18-20. The user interfaces may allow a user to set preferences, opt-in to certain services, etc.

Coupon management system 12 then receives the customer preferences, such as from the data store 52 in mobile device 18. This is indicated by block 102 in FIG. 4. Custom offer generator 60, in coupon management system 12, then determines whether it is time to generate a custom offer. This is indicated by block 104 in FIG. 4. If not, custom offer generator 60 simply waits until it is time. Custom offer generator 60 can determine whether it is time to generate a custom offer (or targeted offer) based on all of the criteria mentioned thus far. For instance, if a user has opted into geographic services, then custom offer generator 60 may determine whether the user is approaching a retail establishment for which the user has chosen to receive offers (or coupons). For instance, if the user is walking into a department store and the user has opted into the geographically based promotion services, then the user may receive, from coupon management system 12, coupons that may be redeemed at that department store. Similarly, if the user, in the user preferences, has indicated that the user wishes to receive offers (or coupons) at a particular time of day (perhaps the user normally goes shopping at that time of day) and on a particular day of the week, custom offer generator 60 may generate an offer at that time. Of course, custom offer generator 60 can determine whether offers are to be generated based on a wide variety of other criteria and those mentioned are mentioned for the sake of explanation only.

If custom offer generator 60 determines that it is time to generate a custom (or targeted) offer, then custom offer generator 60 accesses the customer relations management data in data store 14 to determine what particular customers are to receive the offers. For instance, different customers may have requested offers from different retail establishments, or for different products. Therefore, custom offer generator 60 accesses the data in data store 14 to determine whether there are any offers to be generated for those particular customers. This is indicated by block 106 in FIG. 4.

Where the customer has opted into the geographically related services, coupon management system 12 can then receive or access the customer geographical data generated by geographical processing component 50 on mobile device 18. This is optional, and it is shown in phantom as block 108 in FIG. 4.

Having all of the relevant information, custom offer generator 60 then identifies coupons 36 in data store 16 that are to be offered pursuant to the targeted offer generated by custom offer generator 60. This is indicated by block 110 in FIG. 4. As mentioned above, this can be based on the particular stores or products for which the customer has indicated a desire for coupons, the particular retail establishment identified as relevant by the customer, or any of a wide variety of other criteria as well.

Coupon management system 12 then sends coupon numbers (that identify the barcodes on the coupons) to the mobile devices identified by the target offer generated by custom offer generator 60. This is indicated by block 112 in FIG. 4. This is shown in phantom because, in one embodiment, mobile device 18 will already have downloaded desired coupons and they will be stored in data store 52 in the mobile device. In that embodiment, the numbers are simply provided from data store 52 to identify relevant coupons for display to the user. Processing component 54 then displays the relevant coupons to the user on display 42. In one embodiment, the displays include not only a graphical indication of the coupons identified as relevant (such as a picture of the coupons) but may also include advertising text explaining the coupon, or other offer for which coupons are to be redeemed. Displaying an indication of the identified coupons is indicated by block 114 in FIG. 4.

The customer can then select any of the identified coupons for redemption using redeem component 58 of processing component 54 on mobile device 18. As described above, redeem component 58 may simply present actuable user inputs, through an appropriate user interface, that allows the customer to select one of the coupons for redemption. Receiving the customer redemption input is indicated by block 116 in FIG. 4.

Barcode generator 40 then generates a scannable barcode 69 and presents it on display 42 so that it can be scanned by electronic barcode reader 26 at a retail establishment. Generating the barcode for scanning is indicated by block 118 in FIG. 4.

Once the coupon has been rendered for scanning, it is invalidated by processing component 54. In one embodiment, the barcode is simply marked so that it can never be displayed again. However, it can be invalidated, or otherwise marked so that it cannot be reused, in any of a wide variety of other ways as well. Invalidating the coupon for additional uses is indicated by block 120 in FIG. 4.

Finally, processing component 54 returns feedback to coupon management system 12 through feedback/retailer management component 64 indicating that a particular coupon has been rendered for redemption. This information can be aggregated, or otherwise configured, for return as feedback data 44, to the retailers or manufacturers, as desired. Returning the feedback regarding redemption can occur in substantially real time, so the entity offering the coupons can react in substantially real time. This is indicated by block 122 in FIG. 4.

FIG. 5 is a flow diagram better illustrating one embodiment in which barcode generator 40 generates the barcode for scanning. Barcode generator 40 first receives the barcode numbers 61 (such as the UPC code) provided by processing component 54, for coupons that have been selected for redemption. This is indicated by block 200 in FIG. 5. Next, barcode generator 40 converts the numbers into a barcode representation. This can be done in any known way, and it simply identifies a series of bars in the barcode, that correspond to the barcode numbers. This is indicated by block 202 in FIG. 5.

Pixel rendering component 63 then generates pixel values for the barcode representation on a pixel-by-pixel basis by drawing the barcode from the UPC code instead of from some other image. This is indicated by block 204 in FIG. 5. Generating a pixel-by-pixel picture of the barcode generates a very high resolution image or representation of the barcode, without image defects, to assist in scanning the barcode.

The pixel values are then provided by pixel rendering component 63 to graphics engine 67 which renders the barcode on display 42. Providing the barcode representation to the graphics engine and rendering the barcode on display 42 are indicated by blocks 206 and 208 in FIG. 5, respectively.

Frequency modulator component 65 then modulates the brightness intensity of the displayed barcode on display 42 according to a frequency modulation that can be empirically determined. In one embodiment, the barcode actually flashes on and off at a frequency of approximately 60 Hz. Of course, the intensity can be modulated at a different frequency as well. Also, the intensity level may be varied so the barcode representation flashes not from full off to full on, but through a different intensity range. It has been found that frequency modulating the brightness of the barcode representation allows it to be scanned much more accurately by an electronic barcode reader. Frequency modulating the brightness intensity of the barcode is indicated by block 210 in FIG. 5.

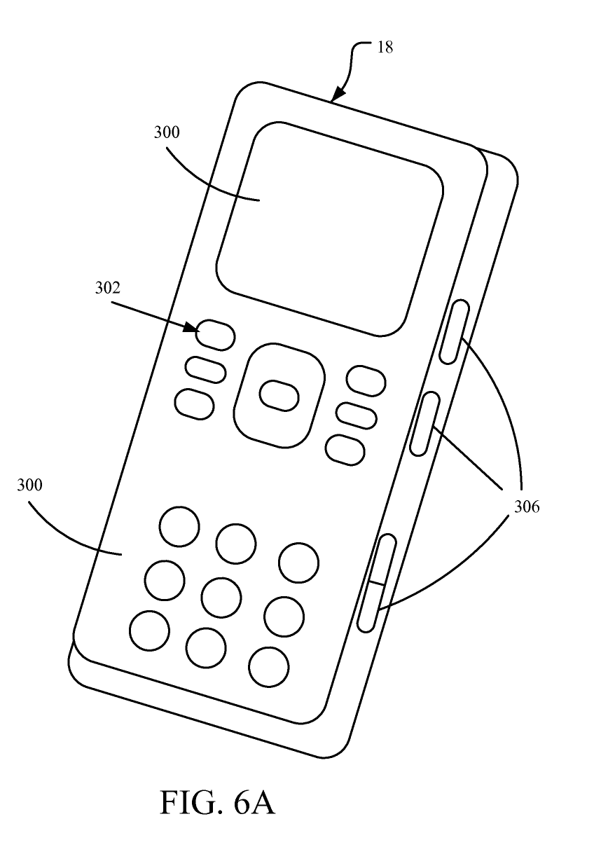

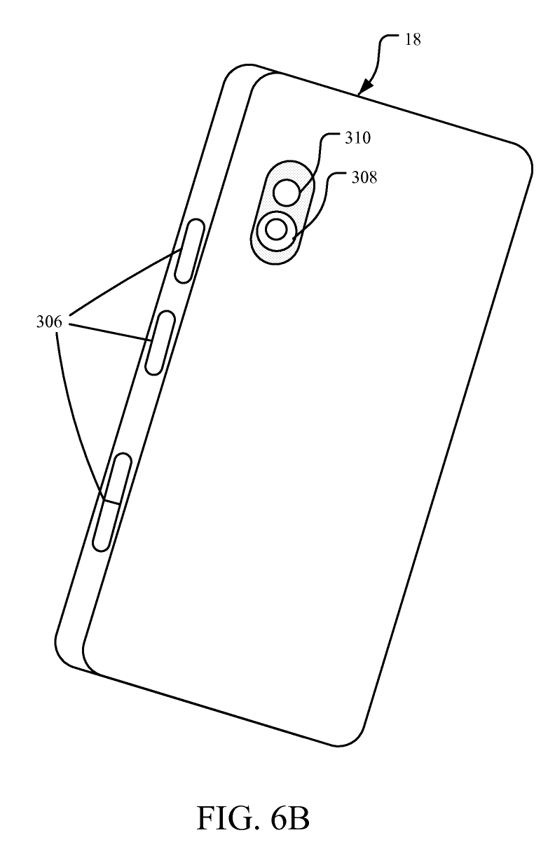

FIGS. 6A-9 show one illustrative embodiment in which barcode, or other, information can be read by a barcode reader, such as a laser barcode scanner. As is generally known, laser scanners work by sending a low energy light beam or laser beam to read the spacing between the pattern on an image, one space at a time. The beam moves back and forth by using a mobile mirror. The light beam is impinged on the pattern to be read, and the reflection returns and is read by a fixed mirror in the scanners. The movement of the light across the barcode causes a blinking effect in the reflected light. The scanner then generates analog and digital signals that match the reflected pattern. A barcode reader and decoder then processes the information and sends it through a data communication interface to a computer or other processor. The image is converted to a series of corresponding numbers and/or letters.

It can thus be seen that the barcode reader illustratively includes a light source, a lens and a light sensor that translates optical impulses into electrical ones. Additionally, many barcode readers include decoder circuitry that analyzes the barcode's image data provided by the light sensor and sends the barcode's content to an output port or other output mechanism of the scanner. In one embodiment, the light sensor is a photodiode that is placed in a position to measure the intensity of the light reflected back from the barcode (or other image that is scanned). The photodiode measures the intensity of the light reflected back from the light source and generates a waveform that is used to measure the widths of the bars and spaces in the barcode. The dark bars in the barcode absorb light and white spaces reflect light so that the voltage waveform generated by the photodiode is a representation of the bar and space pattern in the barcode. The light emitted by the reader can be tuned to a specific frequency, and the photodiode is then designed to detect only modulated light of the same frequency.

FIGS. 6A and 6B illustrate one illustrative mobile device 18, such as a cellular phone. As seen in FIG. 6A, mobile device 18 includes a display screen 300, a cluster of control keys 302, and a set of alphanumeric keys 304. Mobile device 18 may also include a plurality of additional control actuators 306.

Many current mobile devices, such as mobile device 18, also have a variety of light sources on them. For instance, display 300 may be a LED display in which the intensity of the display can be modulated by circuitry within mobile device 18. Similarly, as shown in FIG. 6B, many mobile devices 18 also include cameras. FIG. 6B shows a side of mobile device 18 opposite that shown in FIG. 6A. FIG. 6B also shows that the mobile device 18 can include a camera lens 308 as well as a light source 310, which may be used as a camera flash or simply to illuminate a scene for a picture or video. In one embodiment, discussed in greater detail below, information can be transmitted from mobile device 18 to a point of sale, or other point of use, by controlling light source 310. Light source 310 can be controlled in a blinking pattern that mimics laser light reflected to a laser scanner when the scanner is reading a barcode, or other encoded image.

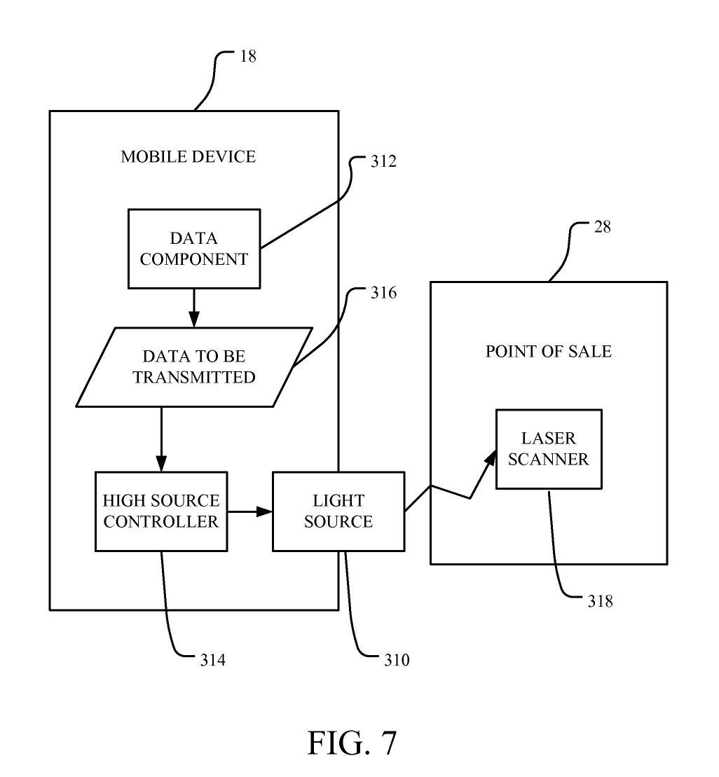

FIG. 7 is a block diagram illustrating this in greater detail. FIG. 7 shows that mobile device 18 illustratively includes data component 312 and light source controller 314, which is connected to light source 310. Data component 312 illustratively receives data corresponding to a blinking pattern associated with a code to be read by a laser bar code scanner. This information can be any information which mobile device 18 is to transmit to a point of sale or point of use 28. For instance, the data 316 to be transmitted may be a barcode corresponding to an item to be purchased at point of sale 28. Data 316 may also include credit card information, user identification information, a barcode or other code associated with a ticket, debit card information, hotel check-in information, flight boarding pass information, etc. Basically, data 316 to be transmitted can be any information which is to be transmitted to a point of sale or point of use 28. As shown in FIG. 7, the point of use 28 is a point of sale, and it includes a laser scanner 318.

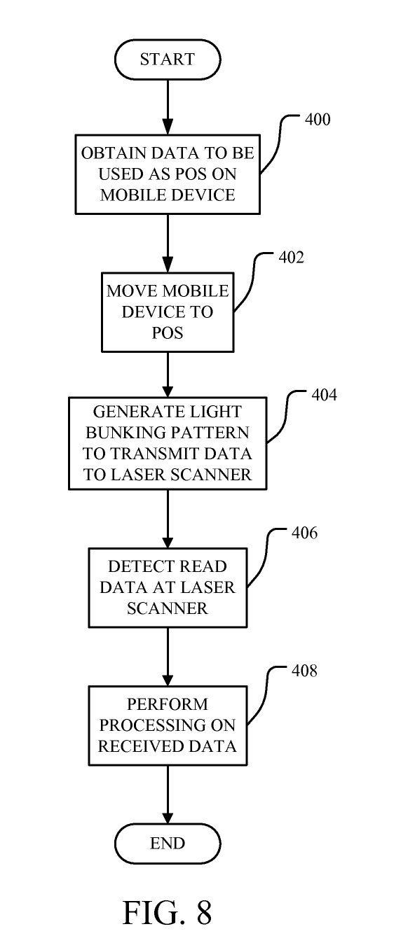

FIG. 8 is a flow diagram illustrating one embodiment of the overall operation of the system shown in FIG. 7. Mobile device 18 first receives, through data component 312, the data to be used at the point of sale or point of use 28. This can be done using a network, such as system 10 shown above in FIG. 1, or any using any other desired mechanism for inputting the data 316, to be transmitted into mobile device 18. This is indicated by block 400 in FIG. 8.

Mobile device 18 is then moved into a region proximate the point of sale or point of use 28. Point of sale 28 may include a cradle or holding device for holding mobile device 18 in close proximity to laser scanner 318. In any case, mobile device 18 is moved to a region proximate point of sale or point of use 28 so the laser scanner 318 can receive the data 316 transmitted from mobile device 18. This is indicated by block 402 in FIG. 8.

Light source controller 314 receives the data to be transmitted 316 and controls light source 310 such that it emits a blinking pattern corresponding to the data 316. For instance, where data 316 represents a barcode, then the blinking pattern corresponds to the light reflected back to laser scanner 318, if laser scanner 318 were actually scanning the barcode represented by data 316. It should be noted that the frequency of the light emitted by light source 310 may vary with different applications. Suffice it to say that it will be light with a frequency that is detectable by the photodiode (or other light sensor) used by laser scanner 318. The frequency of the blinking pattern may also vary, based on the nominal scanning speed of the laser scanner. Generating the blinking pattern to transmit data 316 to laser scanner 318 is indicated by block 404 in FIG. 8. Data 316 is then detected and read (or decoded) at laser scanner 318. This is indicated by block 406 in FIG. 8. The alphanumeric representation (or other representation) of data 316 is then received at point of sale or point of use 28 and it is further processed, as desired, or required, at point of sale or point of use 28. Performing the further processing on the received data is indicated by block 408 in FIG. 8.

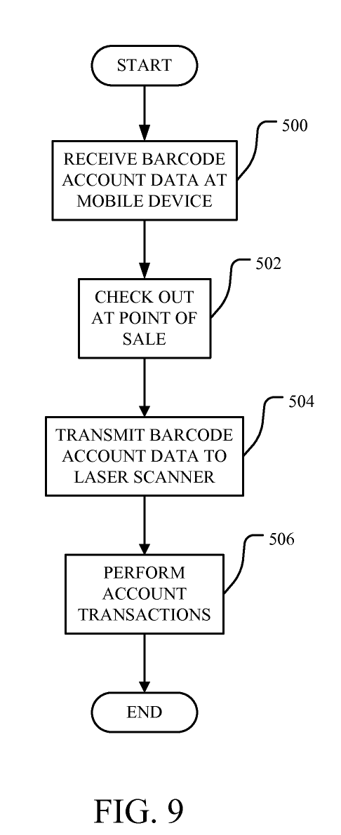

FIG. 9 is a flow diagram illustrating, in more specificity, the operation of the system shown in FIG. 7, in accordance with one illustrative embodiment. The embodiment described with respect to FIG. 9 is an application in which the data 316 to be transmitted to point of sale 28 corresponds to a credit card, or prepaid debit card.

Mobile device 18 first receives the barcode account data. That data may, illustratively, include the credit card or debit card account number along with an expiration date or any other verifying or authenticating information that may be required. The data may also include, in the case of a debit card, a prepaid currency amount associated with the debit card. Receiving the barcode account data at mobile device 18 is indicated by block 500 in FIG. 9.

It is next assumed that the user wishes to use the credit or debit card account to pay for an item. Therefore, the user proceeds to the point of sale or point of use 28 to check out, and tender payment using the credit or debit card account. This is indicated by block 502 in FIG. 9.

Once the cashier has accumulated the total currency amount due for the items to be purchased at the point of sale, the user transmits the barcode account data to the laser scanner 318 in the manner described above with respect to FIG. 8. This is indicated by block 504 in FIG. 9. The processing components at point of sale 28 then perform account transactions, such as posting a sale against the credit card or debit card account, and reducing the currency available in the case of a prepaid debit card. This is indicated by block 506 in FIG. 9.

It will, of course, be appreciated that this embodiment can be used in a wide variety of different applications as well. For instance, where mobile device 18 has access to a wide area network, boarding pass information can be downloaded to mobile device 18 wherein the boarding pass information represents a boarding pass for an airline or other transportation reservation. In that case, the data 316 to be transmitted to the point of use 28 is the barcode information corresponding to the boarding pass. The laser scanner 318 is embodied as a laser scanner at the boarding gate of an airport or bus terminal or other transportation system. Of course, the same embodiment can be deployed to be used with any other type of reservation, such as a hotel or restaurant reservation, or with any other type of ticket, such as theater or sporting event tickets.

Similarly, instead of being a debit or credit card account, the data 316 may be information that identifies a checking account or other bank account. In that case, when the data is transmitted to laser scanner 318, the checking or other bank account may simply be updated to reflect that currency has been transferred from that account to another account, to pay for the goods just purchased.

Data 316 may also be identification information that identifies a user. That information, for example, might identify a user's membership number in a health club or other organization that requires membership. The information may also include an identification in a patronage program such as a frequent flyer or other frequent purchaser program. This may allow the user to redeem points earned in that patronage program, or otherwise identify the user as a member of the patronage program. The information may also include gift card information that identifies an account that has a currency value associated with it.

It will also be noted that light source 310 can be any light source which reflects light having a frequency that is detected by a laser scanner. For example, if the intensity of light emitted by display screen 300 is sufficient to be detected by a laser scanner, and if it can be modulated to emit a blinking pattern that can be detected by a laser scanner, then display screen 300 can be used as the light source 310. Alternatively, many mobile devices have a variety of different light emitters thereon, any of which can be used, so long as they emit light in a frequency range that can be detected by a laser scanner, and can be controlled to emit the blinking pattern that can be detected by a laser scanner.

It can thus be seen that the present system not only provides a barcode generator that generates scannable barcodes corresponding to coupons at a point of sale location for obtaining discounts, but it provides an overall architecture that manages the distribution and feedback corresponding to those coupons. The architecture allows a user to download specific coupons, to search for deals or coupons that may be available and desirable by the user, to redeem coupons, and to opt-in to location services that provide targeted offers based on the specific geographic location of a user using a mobile device. It also allows information to be transmitted to a laser scanner as well.

Although the present invention has been described with reference to preferred embodiments, workers skilled in the art will recognize that changes may be made in form and detail without departing from the spirit and scope of the invention.

What is claimed is:

1. A method of transmitting information from a mobile device to a laser scanner at a point of use, comprising:
obtaining, on the mobile device, alphanumeric data to be transmitted to the laser scanner; and
controlling a light source on the mobile device to emit light in a blinking pattern that represents the data to be transmitted, the light having a frequency detectable by the laser scanner such that the laser scanner detects the blinking pattern of the light emitted by the light source and obtains the alphanumeric, patronage data based on the detected blinking pattern detected.

2. The method of claim 1 wherein the point of use comprises a point of sale and further comprising:
moving the mobile device proximate the laser scanner such that the laser scanner can detect the light emitted by the light source.

3. The method of claim 1 wherein obtaining alphanumeric data comprises:
obtaining account data for a credit or debit card account.

4. The method of claim 1 wherein obtaining alphanumeric data comprises:
obtaining membership data indicative of a membership in an organization.

5. The method of claim 1 wherein obtaining alphanumeric data comprises:
obtaining boarding pass data indicative of a boarding pass for a transportation system.

6. The method of claim 1 wherein obtaining alphanumeric data comprises:
obtaining personal identification data indicative of a personal identification of a user.

7. The method of claim 1 wherein obtaining alphanumeric data comprises:
obtaining bank account data indicative of a bank account number of a user.

8. The method of claim 1 wherein obtaining alphanumeric data comprises:
obtaining ticket data indicative of a ticket to an activity or event.

9. The method of claim 1 wherein obtaining alphanumeric data comprises:
obtaining reservation data indicative of a reservation for a user.

10. The method of claim 1 wherein obtaining alphanumeric data comprises:
obtaining boarding pass data indicative of a boarding pass for a transportation system.

11. The method of claim 1 wherein obtaining alphanumeric data comprises:
obtaining patronage program data indicative of a user's participation in a patronage program.

12. The method of claim 1 wherein obtaining alphanumeric data comprises:
obtaining pre-paid currency card data indicative of an amount of pre-paid currency associated with a pre-paid currency card.

13. A mobile device, comprising:
a data component receiving alphanumeric data to be transmitted to a laser scanner at a point of use and generating a representation of the alphanumeric data to be transmitted to the laser scanner;
a light source emitting light at a frequency that it can be detected by the laser scanner; and
a light source controller receiving the representation of the alphanumeric data and controlling the light source to emit light in a blinking pattern based on the representation of the alphanumeric data such that the laser scanner detects the blinking pattern and decodes it to obtain the alphanumeric data that represents membership information.

14. The mobile device of claim 13 wherein the light source comprises a camera flash light source.

15. The mobile device of claim 13 wherein the light source comprises a display screen.

16. The mobile device of claim 13 wherein the mobile device comprises a cellular telephone.

17. A system for transmitting data to a point of sale, comprising:
a mobile device having stored thereon data to be transmitted to the point of sale, the mobile device including a light source and a light source controller, the light source controller controlling the light source to emit light in a blinking pattern, based on the data to be transmitted, that simulates light reflected to a laser scanner when the laser scanner reads a barcode that represents the data to be transmitted; and
a laser scanner detecting the light emitted by the light source in the blinking pattern and generating a representation of the data based on the light detected, the data representing boarding pass information.

18. The system of claim 17 wherein the light source emits in a visible frequency range.

19. The system of claim 17 wherein the mobile device comprises a cellular telephone.

20. The system of claim 17 wherein the light source comprises a camera flash light source.
